(19) United States
(12) Patent Application Publication
(10) Pub. No.: US 2019/0308337 A1
(43) Pub. Date: Oct. 10, 2019

(54) RELIEF GUARD FOR HAND TOOLS

(71) Applicant: SWANSTROM TOOLS USA INC., Superior, WI (US)

(72) Inventor: John O. Swanstrom, Maple, WI (US)

(21) Appl. No.: 16/375,365

(22) Filed: Apr. 4, 2019

Related U.S. Application Data
(60) Provisional application No. 62/652,500, filed on Apr. 4, 2018.

(51) Int. Cl. B26B 29/04

(52) U.S. Cl. CPC B26B 29/04

(57) ABSTRACT

A cutter comprising a first cutting portion having a first cutting edge, a second cutting portion having a second cutting edge and pivotally coupled to the first cutting portion, a relief aperture defined by the first and second cutting portions adjacent the first and second cutting edges, and a relief guard coupled to the first and second cutting portions to at least partially cover the relief aperture such that an object to be received between the first and second cutting portions is restricted from entering the relief aperture.

### CROSS-REFERENCE TO RELATED APPLICATION

This application claims priority to Provisional Application No. 62/652,500, filed Apr. 4, 2018, which is herein incorporated by reference in its entirety.

### TECHNICAL FIELD

The present invention is in the field of hand tools. More specifically, the present invention is directed to hand tools for cutting and having a relief guard.

### BACKGROUND

Traditionally, severing hand tools, such as shears and cutters, are configured to sever objects, such as wires, when the objects are positioned between the cutting edges. However, it is difficult to position a wire to between the cutting edges with high accuracy and repeatability, especially at high volume operations. This is largely due to over-insertion of an object beyond the cutting edges and into a stress relief aperture adjacent the cutting edges. There remains a continuing need for improved hand tools enabling a user to position an object between the cutting edges with increased accuracy and repeatability.

### SUMMARY

Various aspects of the disclosure relate to cutters comprising a first cutting portion having a first cutting edge, a second cutting portion having a second cutting edge and pivotally coupled to the first cutting portion. The cutters may further include a relief aperture defined by the first and second cutting portions adjacent the first and second cutting edges. The cutters may further include a relief guard coupled to the first and second cutting portions to at least partially cover the relief aperture such that an object to be received between the first and second cutting portions is restricted from entering the relief aperture.

Additionally, various aspects of the disclosure relate to hand tool kits including a hand tool and a plurality of relief guards configured to be coupled to the hand tool. The hand tool may include a first cutting portion having a first cutting edge and a second cutting portion having a second cutting edge and pivotally coupled to the first cutting portion. The hand tool may further include a relief aperture defined by the first and second cutting portions adjacent the first and second cutting edges. Each of the relief guards may differ by at least one of a length, an angle, and a width, and configured to at least partially cover the relief aperture such that an object to be received between the first and second cutting portions is restricted from entering the relief aperture.

While multiple inventive examples are specifically disclosed, various modifications and combinations of features from those examples will become apparent to those skilled in the art from the following detailed description. Accordingly, the disclosed examples are meant to be regarded as illustrative in nature and not restrictive.

### BRIEF DESCRIPTION OF THE DRAWINGS

FIG. 1 shows a cutter in a closed position, according to some examples.

FIG. 2A shows the cutter of FIG. 1 absent a relief guard, viewing from the front, according to some examples.

FIG. 2B shows the cutter of FIG. 1, including a catch, viewing from the side, according to some examples.

FIG. 3 shows the cutter of FIG. 1 in an opened position absent the relief guard, according to some examples.

FIG. 4 shows a cross-sectional view (A-A section) of the cutter of FIG. 3 with the relief guard, according to some examples.

FIG. 5 shows the cutter of FIG. 1 having an object positioned between the cutting edges and adjacent the relief guard, according to some examples.

FIG. 6 shows the cutter of FIG. 1 having a relief guard with stabilizing elements, according to some examples.

FIG. 7 shows a cutter, viewing from the side, according to some examples.

FIG. 8 shows a cross-sectional view (B-B section) of the cutter of FIG. 7, according to some examples.

While the disclosure is amenable to various modifications and alternative forms, specific embodiments have been shown by way of example in the drawings and are described in detail below. The disclosure, however, is not limited to the particular embodiments described. On the contrary, the disclosure is intended to cover all modifications, equivalents, and alternatives falling within the scope of the disclosure as defined by the appended claims.

### DETAILED DESCRIPTION

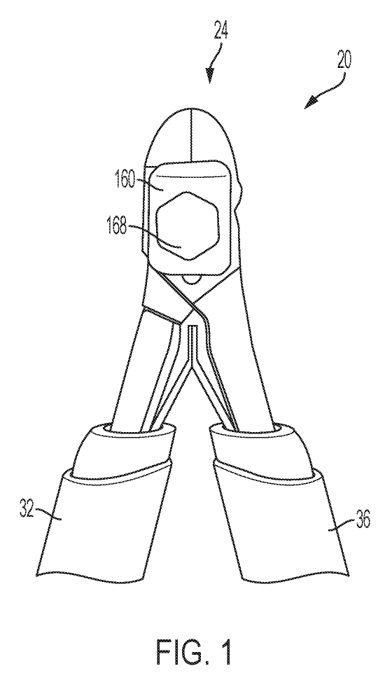

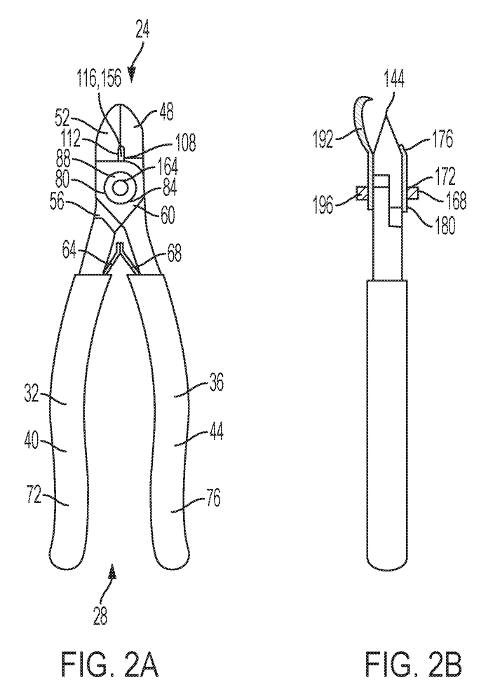

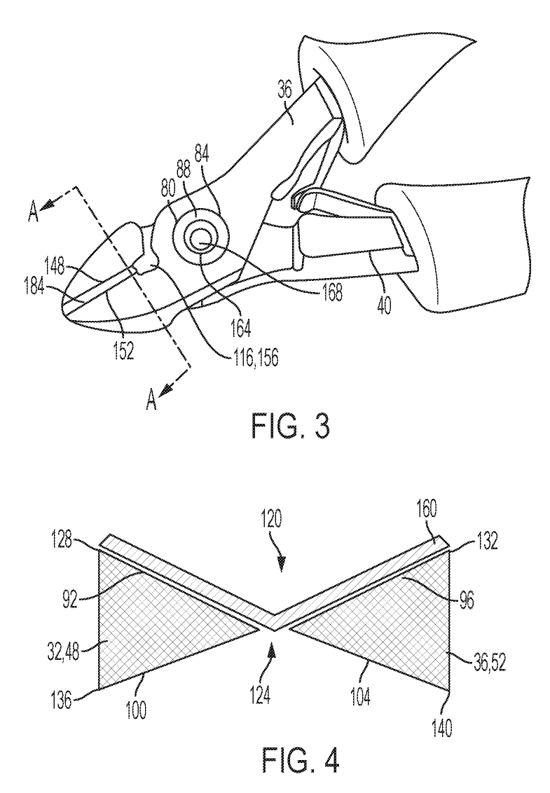

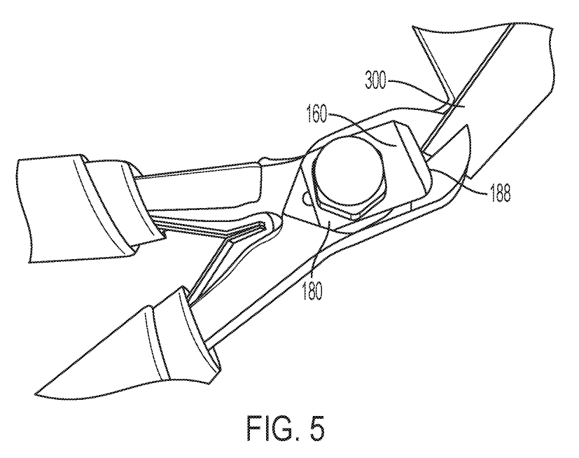

FIG. 1 shows a cutter 20 in a closed position, according to some examples. FIG. 2A shows the cutter 20 of FIG. 1 absent a relief guard 160, viewing from the front, according to some examples. FIG. 2B shows the cutter 20 of FIG. 1, including a catch 192, viewing from the side, according to some examples. FIG. 3 shows the cutter 20 of FIG. 1 in the opened position absent the relief guard 160, according to some examples. FIG. 4 shows a cross-sectional view (A-A section) of the cutter 20 of FIG. 3 with the relief guard 160, according to some examples. FIG. 5 shows the cutter 20 of FIG. 1 having an object 300 positioned between the cutting edges 148, 152 and adjacent the relief guard 160, according to some examples. It is to be understood that the features described for the cutter 20 in the present disclosure may by adapted to any other hand tool known to one skilled in the art. The cutter 20 includes a distal end 24, a proximal end 28, a first arm member 32 (also described as a first jaw member 32), and a second arm member 36 (also described as a second jaw member 36). Each of the arm members 32, 36 includes a handle portion 40, 44 extending from the proximal end 28, a cutting portion 48, 52 extending from the distal end 24, and a pivot portion 56, 60 between the handle and cutting portions, respectively. Each of the arm members 32, 36 may further include a spring 64, 68, respectively, to bias the cutter 20 into an opened position (see FIG. 3). Each of the arm members 32, 36 may further include a handle cover 72, 76, respectively. Each of the arm members 32, 36 includes a pivot opening 80, 84 at the pivot portion 56, 60, respectively, and configured to receive a pivot member 88 to pivotally couple the arm members.

As shown, each of the arm members 32, 36 has a front surface 92, 96 and a back surface 100, 104, respectively, at the cutting portions 48, 52. The front surfaces 92, 96 may be configured to be mirrored (e.g., mirrored from a cutting plane) and may be flat, and/or slanted (e.g., by at least 15°), or curved, and may define a front cutting pocket 120 (see FIG. 4). Additionally or alternatively, the back surfaces 100, 104 may be configured to be mirrored (e.g., mirrored from a cutting plane) and may be flat, and/or slanted, or curved, and may define a back cutting pocket 124 (see FIG. 4). Each of the arm members 32, 36 has a front edge 128, 132, and a back edge 136, 140, in which the distance (i.e., height) between the front and back edge is greater near the pivot portion 56, 60 than near the distal end 24 of the cutter 20 (FIG. 4). The front edges 128, 132 and back edges 136, 140 may meet at the distal end to form a tip 144. Each of the arm members 32, 36 has a cutting edge 148, 152 at the cutting portion 48, 52. The cutting edges 148, 152 are configured to mate in the closed position and may extend from the distal end 24 or the tip 144. The cutting edges 148, 152 may be linear and define a cutting line in the closed position. The cutting line may further define the cutting plane in which the cutter 20 on one side of the cutting plane is generally mirrors the cutter on the other side of the cutting plane.

As shown, each of the arm members 32, 36 may include a recess 108, 112 at the cutting portion 48, 52 near the pivot portion 56, 60, respectively. For example, the recesses 108, 112 may adjacent the cutting edges 148, 152 near the pivot portions 56, 60. As shown in FIG. 2A, the recesses 108, 112 are configured to form a stress relief aperture 116 of the cutter 20 when in the closed position. Alternatively or additionally, the stress relief aperture 116 may be a stripping aperture 156 configured to remove an outer portion (e.g., wire insulation) and not an inner portion (e.g., metal wire) of an object 300 (e.g., electrical wire). The cutter 20 further includes a relief guard 160 configured to be coupled, such as removably coupled to the cutter, such as to the pivot portions 56, 60. For example, the cutter 20 or the pivot member 88 may define a securing opening 164 configured to receive a first securing element 168 (e.g., a bolt, a screw, a magnet, or a clip) to secure the relief guard 160 to the cutter 20 (e.g., the first securing element 168 may be manually secured (e.g., rotated) by a user. The relief guard 160 may define a securing opening 172 configured to be aligned to the first securing element 168. The relief guard 160 may be adjusted, such as slideably adjusted relative to the cutter 20, (e.g., when at least one of the securing openings 164, 172 is a slot). The relief guard 160 may be coupled to the front and/or the back of the cutter 20. As shown in FIG. 2B, the cutter 20 may further include a catch 192, such as a lead catch, configured to be coupled to the cutter to contain and/or limit the length of the severed portion of an object. The catch 192 may be coupled to the cutter 20 on the same or opposite side of the relief guard 160 by the first securing element 168 or a second securing element 196.

As shown in FIG. 1 and FIG. 2B, the relief guard 160 may include a distal portion 176 and a proximal portion 180 generally in contact with the pivot portion 56 or 60. The distal portion 176 may be configured to contact or be near the front 92, 96 and/or the back 100, 104 surfaces of the cutter 20 in the closed position. For example, the distal portion 176 of the relief guard 160 may take on the shape or curvature of the cutting portions 48, 52 (e.g., to be flushly coupled) to limit interference to the front cutting pocket 120 and/or the back cutting pocket 124. In some examples, the relief guard 160 has a slant, or angle in the distal direction, or longitudinal direction of about 15 degrees or more so that the relief guard 160 generally tracks the surface of the cutting portions 48, 52. The relief guard 160 may also have a centrally-oriented angle or curve (e.g., a valley, or inward angle to define a “v-shape” or bent with an apex angle of about 15 degrees or more, for example. Alternatively, the relief guard 160 may be flat such that the distal and proximal portions 176, 180 are coplanar. The securing opening 172 may be defined by the proximal portion 180 of the relief guard 160. The relief guard 160 is configured to be coupled or secured to the cutter 20 such that the relief aperture 116 is at least partially covered by the relief guard. FIG. 1 shows the relief aperture 116 fully covered by the relief guard 160. In various embodiments, at least one of the arm members 32, 36 define a guard recess (not shown) at the pivot portion 56, 60 configured to receive the relief guard 160 (e.g., to help align the relief guard to the cutting pocket 120 or 124). The relief guard 160 may be metal, plastic, and/or composite.

As shown in FIGS. 3-5, the cutting edges 148, 152 are apart in the opened position to define a cutting opening 184 configured to receive an object 300 to be cut (e.g., notched, severed, trimmed, or otherwise cut). The object 300 may be an electrical wire or a plastic part, such as a length of L-channel or other shape. The cutting opening 184 may extend from the distal end 24 or tip 144 along the cutting edges 148, 152 to the relief guard 160, such as to a distal edge 188 of the relief guard. The cutter 20 including the relief guard 160 enables the object 300 (i.e., object severable by the cutter) to be severable when positioned anywhere along the cutting opening 184. The relief guard 160 help limit the insertion of the object 300 into the cutter 20, for example, the cutting portions 48, 52 such that at least part (e.g., entirety) of the object is positioned outside of the relief aperture 116 as a user actuates the cutter from the opened state to the closed state, as shown in FIG. 5.

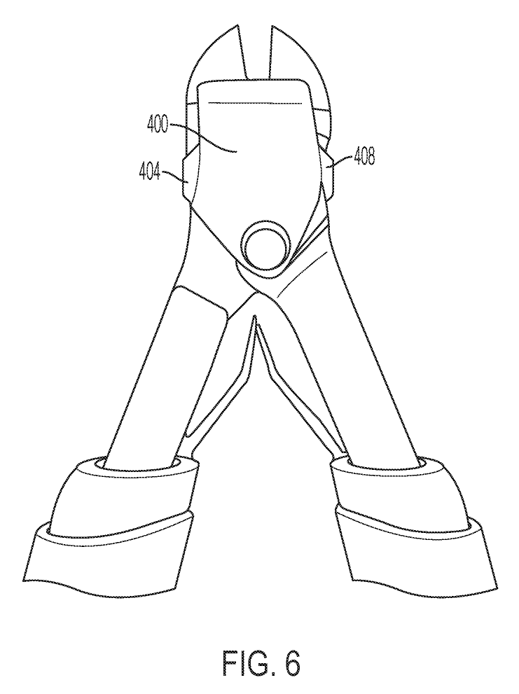

FIG. 6 shows the cutter 20 of FIG. 1 having a relief guard 400 including a first stabilizing element 404 and a second stabilizing element 408, according to some examples. Although a pair of opposing stabilizing elements are shown, it should be understood that a single stabilizing element may be applied as desired. Relief guard 400 may include all features described for relief guard 160 and be used in a cutter substantially the same way. As shown, the first stabilizing element 404 (e.g., also described as a first tab) and optionally a second stabilizing element 408 (e.g., a second tab) may be configured to improve stability of the relief guard 400 such that it remains in position (e.g., coupled flush) during use, such as upon engagement with a workpiece (e.g., object 300 of FIG. 5) or during transition between the opened and closed positions. As shown, each of the first and second stabilizing elements 404, 408 is an angled projection (e.g., bent at approximately 90 degrees) engaging with sides of the first and second arm members 32, 36, respectively to help maintain the relief guard 400 in position (e.g., aligned to cutting portion 48, 52 to cover/block the relief aperture, and optionally portions of the cutting edges).

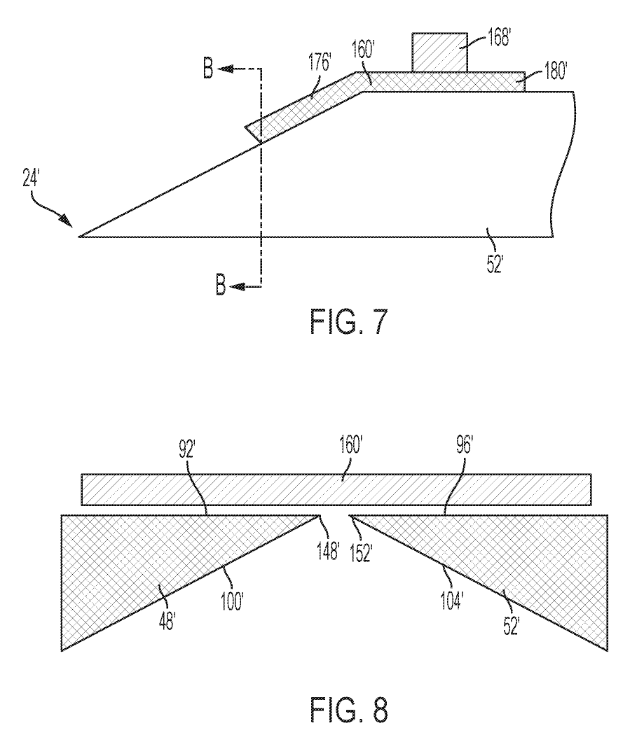

FIG. 7 shows a cutter 20′, viewing from the side, FIG. 8 shows a cross-sectional view (B-B section) of the cutter of FIG. 7, according to some examples. Cutter 20′ may be significantly similar to cutter 20 and may include any of the features described for cutter 20. As illustrated, cutter 20′ includes a first cutting portion 48′ and a second cutting portion 52′ near its distal end 24′. The first cutting portion 48′ has a front surface 92′, a back surface 100′, and a first cutting edge 148′. The second cutting portion 52′ has a front surface 96′, a back surface 104′, and a second cutting edge 152′. Cutter 20′ further include a relief guard 160′ coupled to the first and second cutting portions 48′, 52′ by a first securing element 168′. The relief guard 160′ has a distal portion 176′ and a proximal portion 180′ and may generally track the front surfaces 92′, 96′ or back surfaces 100′, 104′ of the cutting portions 48′, 52′ when attached. In the illustrated example, the front surfaces 92′, 96′ are generally parallel or coplanar such that the relief guard 160′ coupleable to the front surfaces may have a generally planar distal portion 176′. The relief guard 160′ may define an angle at the transition of the distal portion 176′ and proximal portion 180′. The angle may be, for example, about 15 degrees, between 5 and 40 degrees, or any of a variety of values. Alternatively or additionally, a cross-section of the distal portion 176′ may be V-shaped or U-shaped.

A hand tool kit may include a hand tool, such as hand tool 20, and a plurality of relief guards configured to be coupled to the hand tool. One or more of the plurality of relief guards may be similar or identical to relief guard 160. The hand tool of the hand tool kit may include a first cutting portion having a first cutting edge, a second cutting portion having a second cutting edge and pivotally coupled to the first cutting portion. The hand tool may further include a relief aperture defined by the first and second cutting portions adjacent the first and second cutting edges. Each of the plurality of relief guards may differ by at least one of a length, an angle, and a width, and configured to at least partially cover the relief aperture such that an object, such as object 300, to be received between the first and second cutting portions is restricted from entering the relief aperture. The hand tool kit may further include one or more catches coupleable to the hand tool of the hand tool kit by one of one or more securing elements. At least one of the one or more catches may be similar or identical to catch 192. Each of the one or more catches may differ by at least one of a length, an angle, a curvature, and a width.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A cutter comprising:
a first cutting portion having a first cutting edge;
a second cutting portion having a second cutting edge and pivotally coupled to the first cutting portion;
a relief aperture defined by the first and second cutting portions adjacent the first and second cutting edges; and
a relief guard coupled to the first and second cutting portions to at least partially cover the relief aperture such that an object to be received between the first and second cutting portions is restricted from entering the relief aperture.

2. The cutter of claim 1, wherein at least one of a front cutting pocket and a back cutting pocket is defined by the first and second cutting portions.

3. The cutter of claim 2, wherein the relief guard includes a proximal region and a distal region configured to be generally flush against either the front or back cutting pockets.

4. The cutter of claim 1, wherein the relief guard is adjustably coupled to the first and second cutting portions.

5. The cutter of claim 1, wherein the relief guard defines an adjustment slot.

6. The cutter of claim 1, wherein the first cutting portion extends from a first arm member and the second cutting portion extends from a second arm member, and further wherein each of the first and second arm members has a pivot portion to which the relief guard is coupled.

7. The cutter of claim 1, further comprising a distal end and the relief guard including a distal edge, wherein the cutting edges define a cutting opening extending from the distal end to the distal edge.

8. The cutter of claim 1, wherein the relief aperture includes a stripping feature.

9. The cutter of claim 1, further comprising a catch coupled to either the first arm member or the second arm member to contain a severed portion of the object.

10. The cutter of claim 1, wherein the relief guard further include one or more stabilizing elements.

11. A hand tool kit comprising:
a hand tool including,
a first cutting portion having a first cutting edge;
a second cutting portion having a second cutting edge and pivotally coupled to the first cutting portion;
a relief aperture defined by the first and second cutting portions adjacent the first and second cutting edges; and
a plurality of relief guards configured to be coupled to the hand tool, each of the relief guards differing by at least one of a length, an angle, and a width, wherein each of the relief guards is configured to at least partially cover the relief aperture such that an object to be received between the first and second cutting portions is restricted from entering the relief aperture.

12. The kit of claim 11, further comprising one or more catches, wherein any of the one or more catches coupleable to the hand tool by one or more securing elements.

13. The kit of claim 12, wherein each of the one or more catches differing by at least one of a length, an angle, a curvature, and a width.

14. A method of assembling a hand tool according to any preceding claim including attaching a relief guard according to any preceding claim to at least partially cover a relief aperture of the hand tool such that an object to be received between cutting portions of the hand tool is restricted from entering the relief aperture.
